(19) United States
(12) Patent Application Publication
(10) Pub. No.: US 2026/0011013 A1
(43) Pub. Date: Jan. 8, 2026

(54) GROUND TRUTH OF SIGNAL AGGREGATE QUANTIFICATION

(71) Applicant: Ventana Medical Systems, Inc., Tucson, AZ (US)

(72) Inventors: William Day, Tucson, AZ (US); Auranuch Lorsakul, Santa Clara, CA (US)

(73) Assignee: Ventana Medical Systems, Inc., Tucson, AZ (US)

(21) Appl. No.: 19/325,252

(22) Filed: Sep. 10, 2025

Related U.S. Application Data
(63) Continuation of application No. PCT/US2024/023390, filed on Apr. 5, 2024.
(60) Provisional application No. 63/496,207, filed on Apr. 14, 2023.

(51) Int. Cl. G06T 7/00

(52) U.S. Cl. CPC G06T 7/0014; G06T 2207/10056; G06T 2207/20081; G06T 2207/30024

(57) ABSTRACT

A digital pathology image collected using bright-field imaging that depicts a slide with a stained sample slice is accessed. A stain intensity that corresponds to at least part of the digital pathology image is detected. A biomarker-intensity-prediction function that linearly relates predicted biomarker-intensity levels to detected stain intensities is accessed. A non-linear confidence function is accessed that relates confidences of a predicted biomarker intensity to the detected intensities of the stain. A predicted biomarker intensity is generated for the at least part of the slide using the detected stain intensity that corresponds to the at least part of the slide and the linear biomarker-intensity-prediction function. A confidence metric for the predicted biomarker intensity is generated using the detected stain intensity that corresponds to the at least part of the slide and based on the confidence function. A result based on the predicted biomarker intensity and the confidence metric is output.

### CROSS-REFERENCE TO RELATED APPLICATIONS

This application is a continuation of International Patent Application No. PCT/US2024/023390, filed on Apr. 5, 2024, which claims the benefit of and priority to U.S. Provisional Patent Application No. 63/496,207, titled “Ground Truth of Signal Aggregate Quantification”, filed on Apr. 14, 2023. The entire disclosures of the aforementioned applications are incorporated by reference herein in their entireties for all purposes.

### BACKGROUND

Digital pathology may involve the interpretation of digitized images in order to correctly diagnose subjects and guide therapeutic decision making. In digital pathology solutions, image-analysis workflows can be established to automatically detect or classify biological objects of interest e.g., positive, negative tumor cells, etc. An exemplary digital pathology solution workflow includes obtaining tissue slides, scanning preselected areas or the entirety of the tissue slides with a digital image scanner (e.g., a whole slide image (WSI) scanner) to obtain digital images, performing image analysis on the digital image using one or more image analysis algorithms, and potentially detecting, quantifying (e.g., counting or identify object-specific or cumulative areas of) each object of interest based on the image analysis (e.g., quantitative or semi-quantitative scoring such as positive, negative, medium, weak, etc.).

A common use of digital pathology is to quantify a signal, e.g., a ribonucleic acid signal, in tissue samples to support analysis of gene expression changes in individual diseased cells (e.g., cancer cells), dysregulated normal cells (e.g., immune cells, etc.), and/or healthy cells. Typically, to assess gene expression, image processing is performed to detect signals corresponding to a given stain. More specifically, tissue biopsies or liquid samples (e.g., blood samples) can be processed to fixate the sample and to introduce a stain so as to indicate where a signal of interest is located within the sample.

The degree to which signals may be precisely detected and/or precisely located may depend on the size, density and/or aggregation of cells of a given type or of cells expressing a given gene. For example, if a tissue sample includes a dense population of cells expressing a given gene or a population of cells with a high expression of a given gene, an image of a slice may include a blob of stain color. Accordingly, signal assessments are frequently performed in a relative or qualitative manner and not in a quantitative manner. These approaches can hamper techniques for facilitating a diagnosis, treatment recommendation, prognosis, etc.

### SUMMARY

In some embodiments, a computer-implemented method is provided that comprises: accessing a digital pathology image that depicts a slide with a slice of a sample that was stained using a stain, wherein the digital pathology image was collected using bright field imaging; detecting a stain intensity that corresponds to at least part of the digital pathology image; accessing a linear biomarker-intensity-prediction function that linearly relates predicted levels of biomarker intensities to detected intensities of the stain, wherein the biomarker-intensity prediction function was generated by assessing digital-pathology images of other slides, and wherein the other slides included samples stained with multiple other concentrations of the stain; accessing a confidence function that relates confidences of a predicted biomarker intensity to the detected intensities of the stain, wherein the confidence function is non-linear; generating a predicted biomarker intensity for the at least part of the slide based on the detected stain intensity that corresponds to the at least part of the slide and based on the linear biomarker-intensity-prediction function; generating a confidence metric for the predicted biomarker intensity based on the detected stain intensity that corresponds to the at least part of the slide and based on the confidence function; and outputting a result based on the predicted biomarker intensity and the confidence metric.

The confidence function may include a first portion that linearly relates the confidences of the predicted biomarker intensity to the detected intensities of the stain, and the confidence function may include a second portion that non-linearly relates the confidences of the predicted biomarker intensity to the detected intensities of the stain.

The second portion of the confidence function may correspond to a saturation of the detected intensities of the stain.

The at least part of the slide may be a pixel, and the method may further comprise: generating, for each of a set of other pixels in the digital pathology image, another predicted biomarker intensity for the other pixel based on the detected stain intensity that corresponds to the other pixel and based on the linear biomarker-intensity-prediction function; generating, for each of a set of other pixels in the digital pathology image, another confidence metric for the other predicted biomarker intensity based on the detected stain intensity that corresponds to the other pixel and based on the confidence function; and generating the result based on the predicted biomarker intensity, the other predicted biomarker intensities, the confidence metric and the other confidence metrics.

The method may alternatively or additionally comprise: determining that a stored criterion is satisfied based on the confidence metric; and 6 based on the determination that the stored criterion is satisfied, generating the result in a manner that integrates the predicted biomarker intensity.

The stain may be (for example) an RNA stain, a nuclear protein, or a cytoplasm protein.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTIONS OF THE DRAWINGS

The patent or application file contains at least one drawing executed in color. Copies of this patent or patent application publication with color drawing(s) will be provided by the Office upon request and payment of the necessary fee.

Aspects and features of the various embodiments will be more apparent by describing examples with reference to the accompanying drawings, in which:

FIG. 1 shows an illustrative tissue slice that was stained using in situ hybridization (ISH) illustrating KAPPA mRNA detected with silver (Ag) in the black color and LAMBDA mRNA detected with tyramide SRB in the purple color. FIG. 1A shows six tonsil regions of a wholeslide image. FIG. 1B shows a field-of-view image at 40×.

FIG. 2 illustrates how signals detected by digital pathology may relate to true biomarker expression in accordance with a model of some embodiments of the invention.

FIG. 3 shows an exemplary network for generating a digital pathology image and accurately quantifying stain signals depicted in the digital pathology image.

FIG. 4 shows eleven breast tissue slides stained with different probe concentrations of 0 pM (or “no probe control (NPC)”), 0.625 pM, 0.125 pM, 0.25 pM, 0.5 pM, 1 pM, 2 pM, 4 pM, 8 pM, 16 pM, and 32 pM, respectively, with 15 rectangles located in the tumor regions in each slide.

FIG. 5 shows the breast FOV images as depicted in FIG. 4, overlaid with green superpixel-segments to show isolated spots (red dots) and the number of the signal aggregate blobs (blue numbers) for the probe concentrations of 0 pM (or “no probe control (NPC)”), 0.625 pM, 0.125 pM, 0.25 pM, 0.5 pM, 1 pM, 2 pM, 4 pM, 8 pM, 16 pM, and 32 pM, respectively.

FIG. 6 shows eleven tonsil tissue slides stained with different probe concentrations of 0 pM (or “no probe control (NPC)”), 0.625 pM, 0.125 pM, 0.5 pM, 1 pM, 2 pM, 4 pM, 8 pM, 16 pM, and 32 pM, respectively, with 15 rectangles located in the tumor regions in each slide.

FIG. 7 shows data identifying the total number of spots, isolated spots, and signal aggregate blobs plotted across for the concentrations from 0 pM to 8 pM on breast, prostate, CRC, and tonsil tissue slides, respectively.

FIG. 8 shows the estimated true biomarker intensity as a function of the concentrations for multiple tissue types and signals detected by digital pathology.

FIG. 9 shows exemplary nucleus detection results and labels overlaid on original images.

FIG. 10 shows the number of average spots per cell with ideal biomarker expression lines and error rates plotted across for the concentrations from 0 pM to 32 PM on different tissue types.

FIG. 11 shows results of tumor cell classification (red dots) from non-target cells (green dots) performed using automatic image-analysis in the RNA staining images in prostate cancer with the concentrations of 0.5 pM (left), 4 pM (middle) and 32 pM (right).

FIG. 12 illustrates a process to generate a tumor mask starting from the cell-by-cell classification to group object of the tumor label images, the tumor mask, and the polygon generation. The bottom images are the original images with the concentrations of 16 PM and 0 pM (NPC) overlaid with tumor polygons.

FIG. 13 shows the average spots per cell (left graphs) compared to the average spots per cell within tumor regions together (right graphs) with ideal biomarker expression lines and error rates plotted across for the concentrations from 0 pM to 32 PM on prostate tissue slides.

FIG. 14 shows boxplots of the intensity characteristics for the isolated spots with the concentration of 0.625 pM, 0.125 pM, 0.25 pM, 0.5 pM, 1 pM, 2 pM, 4 pM, 8 pM, 16 pM, and 32 pM.

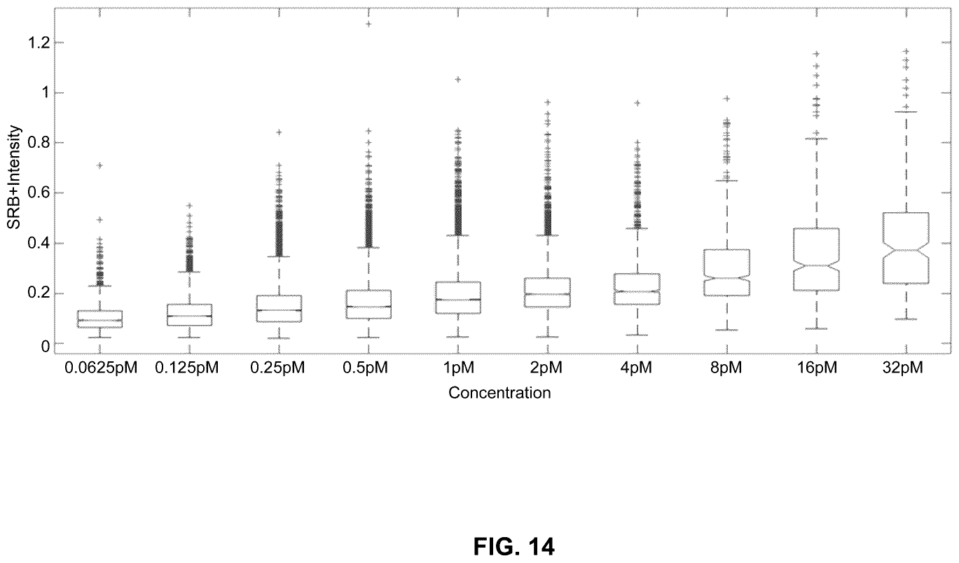

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Some embodiments relate to techniques and systems that facilitate translating images of stained specimens to meaningful quantitative results. For example, techniques and systems may be used to punctate RNA In-situ hybridization (ISH) signal to quantify gene expression, while maintaining tissue context and enabling single cell analysis and workflow. As another example, techniques and systems may be used to translate brightfield image intensities to predicted gene-expression, protein levels, or secreted-substance levels (and/or to error metrics for the same) by using data generated by relating signals to various stain concentrations. In some instances, the data that is used to relate the signals to various stain concentrations corresponds to data where the stain is staining a molecule that is abundantly present in slides.

Many signals detected in the digital pathology context may have been difficult to quantify due to (for example) a high density of cells of a given type or having a given characteristic (e.g., expression of a given gene), the possibility of very high expression (e.g., of a given gene), tight spatial aggregation of cells of a given type or having a given characteristic, etc. For example, one approach for quantifying a biomarker signal can include part or all of one or more approaches for quantifying a signal as disclosed in U.S. application Ser. No. 17/586,982, filed on Jan. 28, 2022, which is hereby incorporated by reference in its entirety for all purposes. The approach can additionally or alternatively include: 1) detecting isolated spots in an image (e.g., an unmixed image channel image corresponding to signals from a biomarker); 2) deriving an optical density value of a representative isolated spot (e.g., based on computed signal features or characteristics from the detected isolated spots); and 3) estimating the number of predictive spots in signal aggregates in each of the sub-regions based on the derived optical density value of the representative isolated spot. The approach can further include estimating a total number of spots in a sub-region by combining a number of detected isolated spots and the estimated number of predictive spots in signal aggregates in each of the sub-regions and aggregating the totals across the full tissue slide(s).

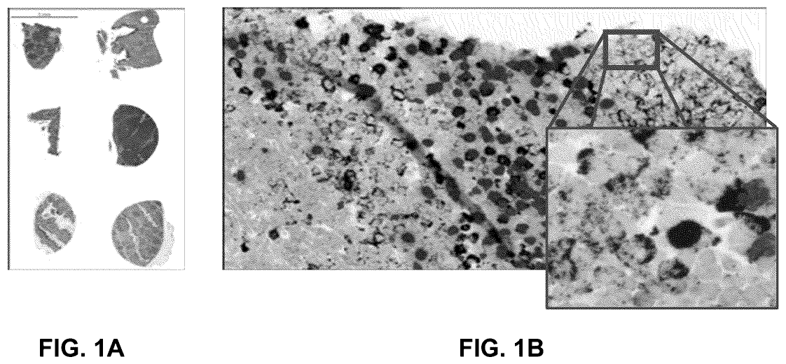

To illustrate, as seen in FIG. 1, tonsil tissue stained for KAPPA mRNA may be detected using a black chromogen (silver, Ag) and LAMBDA mRNA may be detected using a purple chromogen (tyramide-sulforhodamine). The presence of the signal of interest appears as tiny spots (e.g., discrete dots), and these spots may accumulate to form larger regions of aggregate signal (hereinafter “signal aggregate blobs” or “blobs”) depending on the expression level (copy number) of each targeted mRNA in B cells. By way of example, plasma cells have approximately 100,000 mRNA copies per cell, and therefore signal in those cells may appear as blobs. However, it may be difficult to quantify a level of a biomarker (e.g., an expression level of a gene) as represented in any given blob region, given that the stain expression may aggregate and/or may saturate.

It would be useful to be able to reliably translate each signal spot or signal blob into a quantifiable signal metric that represents an amount of an absorbed stain. Further, it would be useful to establish a ground-truth metric that characterizes signal aggregates. These capabilities may facilitate generating more accurate diagnoses or prognoses and/or more accurately predicting the extent to which a given treatment may effectively treat a medical condition of a given subject.

In some embodiments, techniques and systems are provided to generate-with high sensitivity-quantitative immunohistochemical technology (qIHC) signals. The qIHC technology is a new high-sensitivity detection method that has capabilities to detect several types of biomarkers, such as ribonucleic acid (RNA), proteins, and secreted factors, which are low-density biomarkers that govern or influence tumor growth, immune cell activation and/or dysregulation status, and neovascularization. The qIHC technology can overcome limited capabilities over on-marker immunohistochemical (IHC), such as ultraVIEW and OptiVIEW DAB, which can only detect protein biomarkers. For example, existing IHC systems cannot detect secreted factors that exit from the cell and are not present in sufficient densities to generate signals confidently interpreted by pathologists.

Lack of “ground truth” results from an inability to precisely and accurately quantify numbers of target biomarkers in a tissue sample as any method used to extract the molecules includes an undefined loss of material. Accordingly, no measurement is perfectly accurate, and methods used to quantify biomarker abundance all include unknown error and lack of precision. Establishing this ground truth may be practically impossible, as prospectively identifying tissue samples that have biomarkers that cover a full range of presence may be very difficult. This difficulty can be compounded with the realities that a stain absorption may vary across tissue types and potentially other variables (e.g., disease type, subject demographic, cell types, etc.), such that it can be even further to find a training set that covers an applicable range of stain intensities and to determine how to translate slide staining into results useful for generating a function for translating stain intensities.

Meanwhile, embodiments of the invention can identify predicted biomarker levels based on a function generated by relating (in a non-saturating zone) signal intensity to stain concentration. Further, the embodiments can generate predicted error (or confidence) metrics by relating (in a saturating and/or non-saturating zone) predicted biomarker levels to signal intensity. Thus, an artificial ground truth is created and used to facilitate transforming digital-pathology images to metrics representing biomarker levels and to further identifying error (or confidence) metrics for the metrics.

In some embodiments, methods and systems are provided that build and/or use a framework that can be used to quantify and validate signals although ground-truth is unavailable. The signals may include signals from digital-pathology images. The framework may be defined based on or to ensure verification of the accuracy of results and the performance of the quantification methods in a whole-slide analysis scheme. This framework can overcome a limitation of traditional signal detection techniques (e.g., RNA or protein biomarker detection assays and/or algorithm developments) due to the fact that there is no “ground-truth” of signal aggregates in these traditional contexts.

Some embodiments of the invention provide systems, methods and paradigms to circumvent this central and significant obstacle. An abundant biomolecule (e.g., 18 s ribosomal RNA) can be targeted, and probes to detect the abundant biomolecule can be used at a linear range of sub-saturating concentrations. The combination of high-abundance target and sub-saturating probe concentrations eliminates dependency on knowing the absolute abundance of target biomolecules in the sample tested. Moreover, use of a known linear range of probe concentrations enables establishment of a linear regression function, which can then be used to support a determination or documentation of metrics that characterize a performance, reliability and/or error of a signal algorithm or of a predicted biomolecule metric. For example, a framework can be defined based on a hypothesis of a linear relationship between a number of dot signals expressed on a tissue slide and the probe concentrations in the assays.

Thus, disclosed image-processing techniques can detect (e.g., at each pixel or for each region) a signal intensity and translate the signal intensity into a predicted biomolecule level and/or error (or confidence or accuracy) metric. The biomolecule level may be predicted using a linear relationship (which can be established by relating signal intensities to different concentrations of the stain), and the error may be generated based on relationship. The error may be defined based on a cutoff that differentiates a first part of a probe-concentration x-axis that corresponds to a consistent error metric (e.g., that represents a constant additive error amount) and a second part of the x-axis that corresponds to a non-linear and/or non-constant error metric.

Thus, an artificial ground-truth framework can be defined for a stain and tissue type by using a stain to target an abundant biomolecule in a given type of tissue and by evaluating digital pathology signals detected across various concentrations of the stain. The artificial ground-truth framework can be defined to include a linear relationship that relates signals detected using digital-pathology imaging to quantitative predicted biomarker amounts. Moreover, the artificial ground-truth framework can be defined to include a saturation signal level and/or a function that estimates an error of a predicted biomarker amount based on a signal detected using digital-pathology imaging. The stain can then be used to target another biomolecule (that need not be an abundant biomolecule) in the given type of tissue, and the artificial ground-truth framework can be applied to transform digital-pathology signals captured to a quantitative estimate of the other biomolecule level (e.g., for each pixel or region of a slide).

It will be appreciated that the artificial ground-truth framework need not be defined in a manner that supports generating predictions that are accurately identifying—in an absolute sense—true biomarker levels. Rather, the artificial ground-truth framework can be used to essentially generate a new and potentially arbitrary scale that nonetheless is useful in that supports quantitative comparisons of biomarker levels (e.g., so as to support comparing levels across portions of a given slide, across different slides associated with a single sample, across different slides associated with different subjects, across different slides associated with different sample-selection time points, etc.). Moreover, the artificial ground-truth framework can be used to validate the digital pathology algorithms that quantify the predictive signals.

The result(s) (e.g., the predicted biomolecule level and/or the predict error) can be output and/or used to inform diagnoses, prognoses, and/or treatment recommendations. The predicted biomolecule level(s) and/or error metric(s) may additionally or alternatively be used to tune and improve the algorithm parameters to generate a more robust and reliable system.

Various embodiments relate to systems and methods that are built around a hypothesis that a total number of RNA dots has a linear relationship with the RNA probe concentrations. To determine parameters of the linear relationship, tissues (e.g., breast, prostate, CRC, and tonsil) can be stained with different probe concentrations (e.g., of 0 pM (NPC), 0.625 pM, 0.125 pM, 0.25 pM, 0.5 pM, 1 pM, 2 pM, 4 pM, 8 pM, 16 pM, and 32 pM). A digital pathology algorithm can be configured to quantify the total number of RNA dot signals in both forms of isolated dots and aggregate signals and report in terms of the whole-slide analysis. The data may be processed to detect a first range of probe concentrations within which RNA dot counts increase linearly when the probe concentrations increase and a saturation point at which the RNA dot counts plateau. In some instances, the saturation point is assumed to be 8 pM.

While this technique may be used to assess dot signals within a single cell (e.g., a single healthy cell, immune cell or tumor cell) of within larger regions (e.g., tumor regions), averaging RNA dots per cell and averaging RNA dots per cell within tumor regions show smaller of error rates as compared to the total number of RNA dot counts within the entire tumor region. This demonstrates that the RNA dot counts are fitted to the ideal biomarker expression lines within a particular linear range and the error rates become greater after reaching the saturated concentration. On the other hand, processing images in accordance with techniques disclosed herein can lead to accurate estimates of the total number of RNA dot signals for both forms of isolated spots and signal aggregates. This methodology can be a validation method to verify the algorithm performance of signal in stain aggregates.

Additionally, the investigation of isolated spot characteristics of different concentrations have shown to have more understanding of the spot properties. The features of blurriness and size remain the same characteristics throughout the increasing concentrations, whereas intensity and roundness vary with the increasing concentrations.

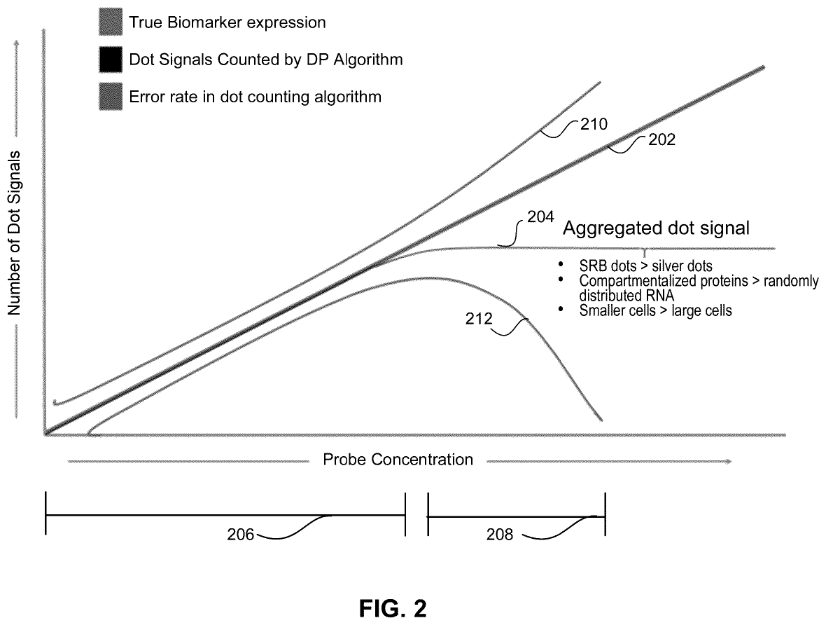

FIG. 2 illustrates proposed underlying relationships that are used in some embodiments to translate stain intensities into predicted biomarker expression and errors. Line 202 shows how (according to embodiments of the invention) the estimated biomolecule intensity may be assumed to vary linearly with the probe concentration. However, as shown by line 204, the signal that is detected varies linearly based on the probe concentration across a first lower portion 206 of probe concentrations but then saturates and remains constant across a second higher portion 208 of probe concentrations. Therefore, the error (as represented by top and bottom error bound lines 210 and 212) of the detected signal is relatively small and constant throughout the first lower portion 206 of probe concentrations but grows substantially throughout the second higher portion 208 of probe concentrations. Therefore, the confidence of the intensity estimates remains relatively high throughout the first portion 206 of probe concentrations but becomes increasingly lower throughout the second portion 208 of probe concentrations.

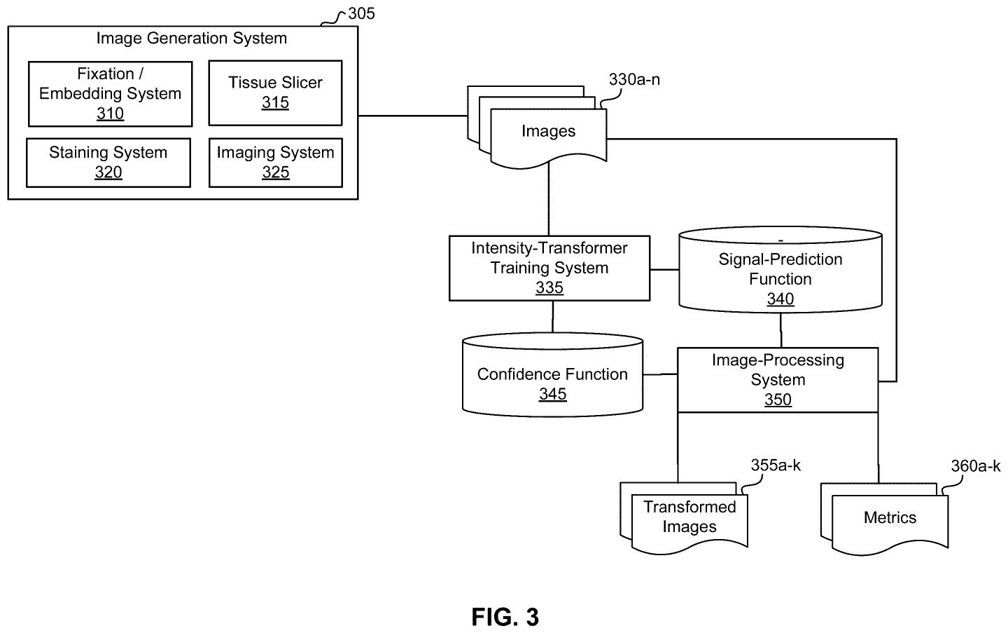

FIG. 3 shows an exemplary network for generating a digital pathology image and accurately quantifying stain signals depicted in the digital pathology image. Images are generated at an image generation system 305. A fixation/embedding system 310 fixes and/or embeds a tissue sample (e.g., a sample including at least part of at least one tumor) using a fixation agent (e.g., a liquid fixing agent, such as a formaldehyde solution) and/or an embedding substance (e.g., a histological wax, such as a paraffin wax and/or one or more resins, such as styrene or polyethylene). Each slice may be fixed by exposing the slice to a fixating agent for a predefined period of time (e.g., at least 3 hours) and by then dehydrating the slice (e.g., via exposure to an ethanol solution and/or a clearing intermediate agent). The embedding substance can infiltrate the slice when it is in liquid state (e.g., when heated).

A tissue slicer 315 then slices the fixed and/or embedded tissue sample (e.g., a sample of a tumor) to obtain a series of sections, with each section having a thickness of, for example, 4-5 microns. Such sectioning can be performed by first chilling the sample and the slicing the sample in a warm water bath. The tissue can be sliced using (for example) using a vibratome or compresstome.

Because the tissue sections and the cells within them are virtually transparent, preparation of the slides typically includes staining (e.g., automatically staining) the tissue sections in order to render relevant structures more visible. In some instances, the staining is performed manually. In some instances, the staining is performed semi-automatically or automatically using a staining system 320.

The staining can include exposing an individual section of the tissue to one or more different stains (e.g., consecutively or concurrently) to express different characteristics of the tissue. For example, each section may be exposed to a predefined volume of a staining agent for a predefined period of time. The staining agent can include (for example) an RNA probe, protein probe (e.g., nuclear-protein probe or cytoplasm-protein probe), an immunohistochemistry stain, a probe for a secreted substance, etc. In some instances, the staining agent is one that stains for KAPPA mRNA or LAMBDA mRNA.

One exemplary type of tissue staining is histochemical staining, which uses one or more chemical dyes (e.g., acidic dyes, basic dyes) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is hematoxylin and cosin (H&E). Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is immunohistochemistry (IHC, also called “immunostaining”), which uses a primary antibody that binds specifically to the target antigen of interest (also called a biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody. The molecular weights of IHC reagents are much higher than those of histochemical staining reagents, as the antibodies have molecular weights of about 150 kD or more.

The sections may then be individually mounted on corresponding slides, which an imaging system 325 can then scan or image to generate raw digital-pathology images 330a-n. Each section may be mounted on a slide, which is then scanned to create a digital image that may be subsequently examined by digital pathology image analysis and/or interpreted by a human pathologist (e.g., using image viewer software). The imaging may include capturing bright-field image of the slide section.

In some instances, a pathologist may review and manually annotate the digital image of the slides (e.g., tumor area, necrosis, etc.). In some instances, annotation of regions of interest are performed automatically using a computer-vision technique.

Some of the digital-pathology images 330a-n may be used by intensity-transformer training system 335 as training data to generate a signal-prediction function 340 that relates an estimated quantity of a stained substance to a depicted stain intensity and/or a confidence function 345 that relates a confidence of the estimated quantity of the stained substance to a stain intensity. Intensity-transformer training system 335 can be configured to use one or more techniques disclosed herein to learn the signal-prediction function 340 and/or the confidence function 345. Intensity-transformer training system 335 may be configured to use the training data to detect a cutoff where a relationship between a stain intensity (e.g., a number of dots, an intensity of a given color, or a color-agnostic intensity) and a stain concentration transitions from being linear to being saturated. Intensity-transformer training system 335 may predict what the relationship is within the linear range. The cutoff and/or the relationship may be separately determined (for example) for each stain and each tissue type. In some instances, the cutoff and/or relationship may further be separately determined for each of one or more demographic and/or disease groups (e.g., such that they are separately determined for each age/sex group of for each of multiple cancer-stage diagnosis groups). Intensity-transformer training system 335 may infer that this linear relationship of the signal-prediction function 340 applies across an entire range of detected stain intensities. However, intensity-transformer training system 335 may further predict, using the confidence function, how a confidence of a predicted signal intensity varies across the detected stain intensity. The confidence may be constant and/or may vary linearly throughout a first lower portion of signal intensities. However, within a second high portion of signal intensities (following a cutoff), the confidence relationship may change. For example, the confidence may be lower and/or the function that is used to predict the confidence may be predominantly based on a nonlinear function.

An image-processing system 350 can be configured to receive other of images 330a-n and to process each of the other images using the signal-prediction function 340 and confidence function 345 to generate a corresponding transformed image (of transformed images 355a-k). Each transformed image may indicate—for a given pixel, region or image itself—a predicted signal intensity and/or confidence metric (which may alternatively or additionally include an error metric). The predicted signal intensity may be based on a linear signal-prediction function. The confidence metric may be based on a biomodal function, where the confidence is constant or linear during a first portion of detected stain intensities but may be nonlinear during a second portion of detected stain intensities. Each transformed image 355a-k may identify—for each pixel or region—a predicted signal intensity and a confidence.

Image-processing system 350 may generate one or more of metrics 360a-k. Each metric 360a-k may correspond (for example) to a region of interest, a volume of interest, an image, and/or a subject. Image-processing system 350 may output one or more transformed images 355a-k and/or one or more metrics 360-a-k to a user device, which may be operated by (for example) a care provider or subject. The transformed images 355a-k may be presented via a GUI, where detected stain signals (e.g., detected dots or blobs) are overlaid on the original digital-pathology images. The GUI may be configured to receive input to add, delete, or more one or more dots or blobs.

The output may be used to generate a predicated diagnosis, prognosis or treatment recommendation. In some instances, image-processing system 350 may use one or more rules or protocols to transform the metric(s) 360a-k to a treatment recommendation, potential diagnosis or potential prognosis.

### EXAMPLES

### Example 1—Artificial Ground Truth Assessment Performed at a Cell-Population/Tissue-Region Level

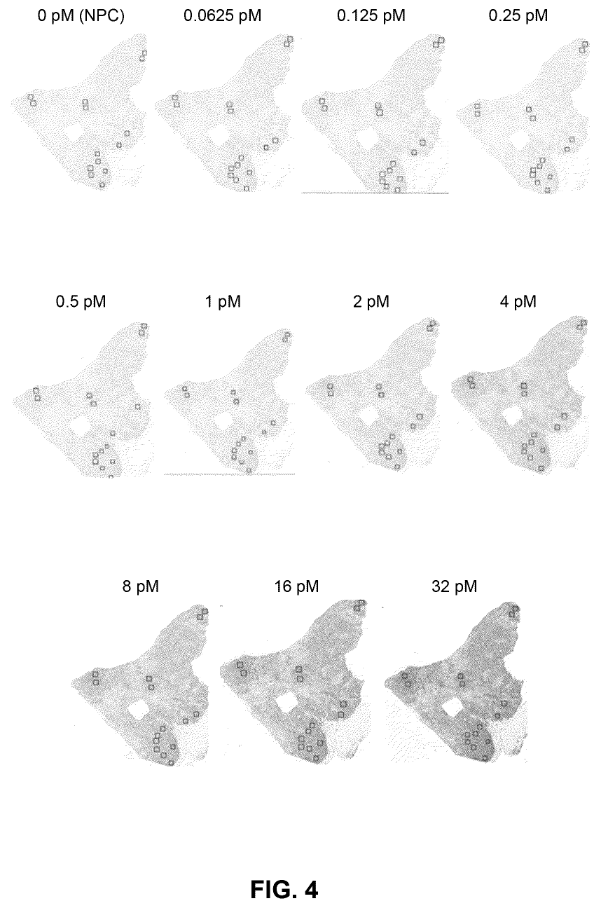

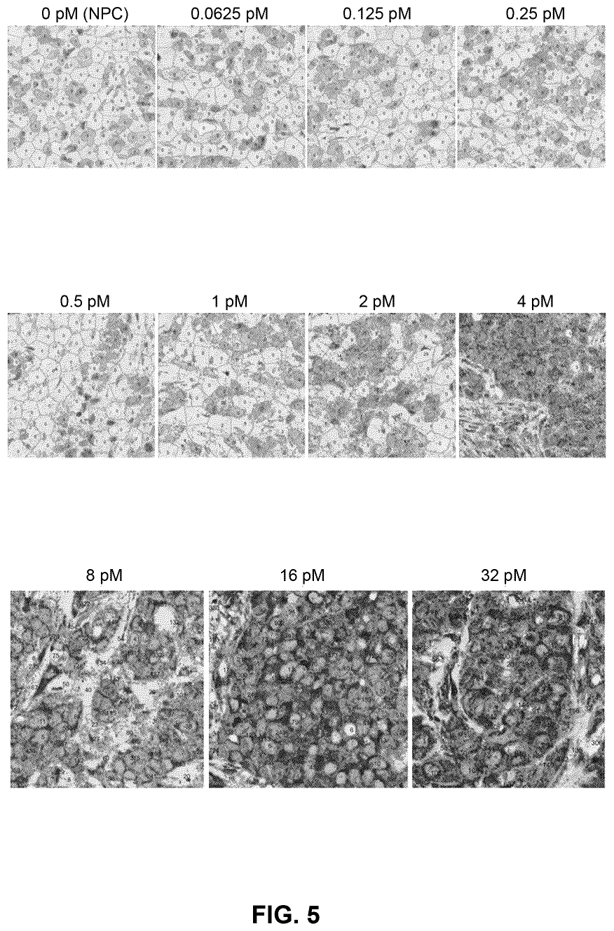

A set of breast-cancer tissue digital pathology slides were accessed, and 15 field-of-view (FOV) images from tumor regions were randomly selected. The summation of the total spot counts (including isolated spots and signal aggregates) from all the 15 FOVs was determined for each slide. For each selected slide, the summation was also performed for other different slides for all the concentrations by locating the FOV position to similar regions to have the most similar tissue morphology. FIG. 4 shows the whole-slide images with 15 rectangles located in the tumor regions, and FIG. 5 shows the example results of the breast FOV images for all the probe concentrations of 0 pM (or “no probe control (NPC)”), 0.625 pM, 0.125 pM, 0.25 pM, 0.5 pM, 1 pM, 2 pM, 4 pM, 8 pM, 16 pM, and 32 pM, respectively, where each breast FOV image is overlaid with our processing method (green segments of superpixel), the isolated spots (red dots) and the number of the signal aggregate blobs (blue numbers). The superpixels were used for visualization for segmenting regions of similar intensity to estimate aggregate dots. Details of how to apply superpixels are described in U.S. application Ser. No. 17/586,982, filed on Jan. 28, 2022, which is hereby incorporated by reference in its entirety for all purposes.

Similar data was collected using prostate-tissue digital pathology slides and colorectal carcinoma (CRC) digital-pathology slides.

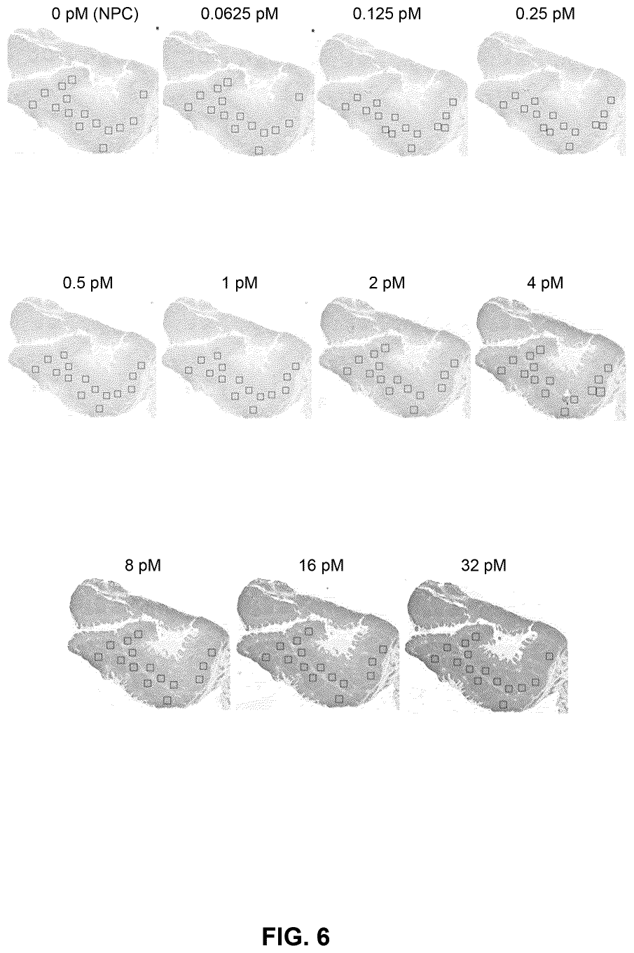

A set of tonsil tissue slides were accessed. The 15 rectangles depicted in FIG. 6 identify tumor regions in the tissue slides. The different images depicted in FIG. 6 show a given tonsil slide that was stained with eleven concentrations of a probe.

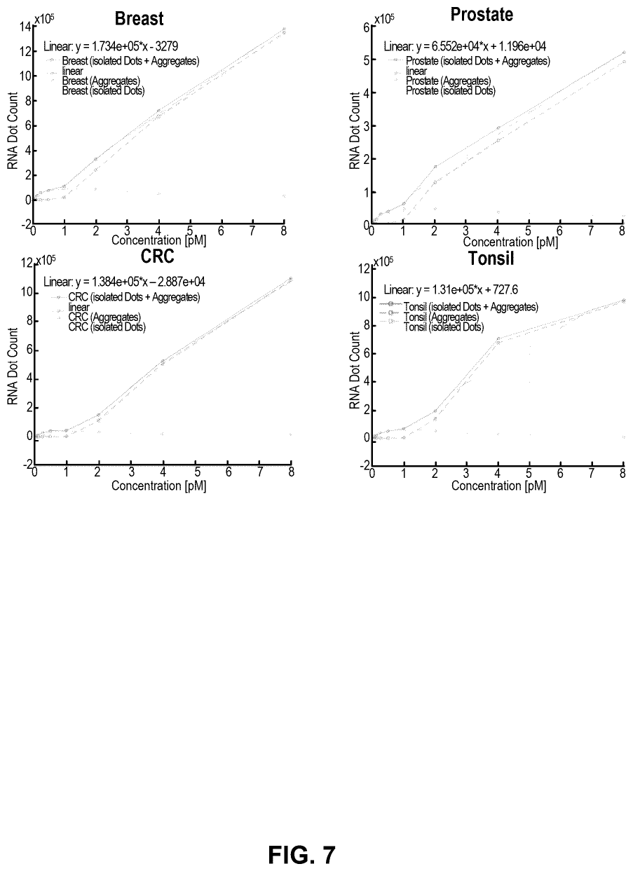

For each of four cancer tissue types (breast, prostate, CRC, and tonsil) and for each of thirteen concentrations, the number of detect isolated dots were identified, as were the number of isolated blobs (or “aggregates”). FIG. 7 shows graphs of these quantities versus the concentrations and a line that shows the sum of the detected isolated dots and the blobs. Theses graphs extend only up until 8 pM, due to embodiments of the invention providing a framework for estimating that digital-pathology signals are linearly reflective of biomarker levels up until a saturation point of 8 pM.

A straight line was fit to the sum of the counts of the detected isolated dots and the blobs versus the concentrations. It can be seen that the linear fit was a strong fit for the breast, prostate and CRC tissues. The linear fit was a poorer fit for the tonsil tissues, which may be because tonsil tissues are rich in immune cells, which are relatively small, so stains may aggregate faster.

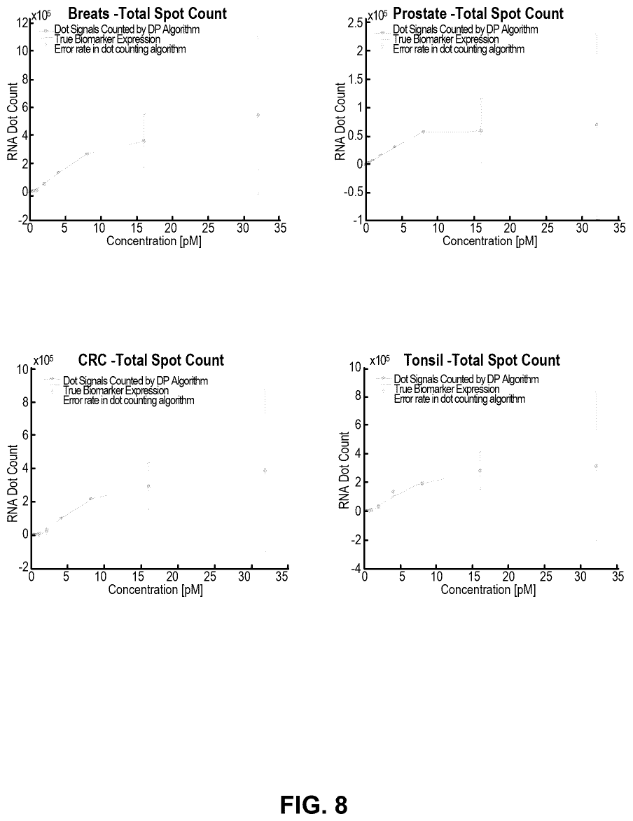

Notably, the experiment performed created artificial-truth data, given that it is known that the detected stain quantity should vary linearly with the different concentrations. However, it was unknown whether the detected signal would show this linearity, given that the stain may not be absorbed in a consistent manner and stain aggregates (e.g., blobs) may obscure what a true biomarker level is. FIG. 8 shows the “true biomarker intensity” as a function of the concentrations for each tissue type, and this is defined as being the linear fits from FIG. 7. Notably, the x-axes of the graphs in FIG. 8 extend beyond the x-axis of the graphs in FIG. 7 and into concentration regions beyond the saturation point.

FIG. 8 also shows the dot counts detected using standard digital-pathology techniques. The error bars in the figures show the error of the detected dot counts relative to the true biomarker levels. For the breast, prostate and CRC tissue date, the error of the dot counts was very small until the cutoff point but then became very sizable at higher concentrations. For the tonsil tissue, the error after the 8 pM concentration were still relatively big, though the error of the signals detected via the digital-pathology techniques were relatively high at lower concentration as compared to the errors for the other tissue types.

### Example 2—Artificial Ground Truth Assessment Performed at a Cell Level

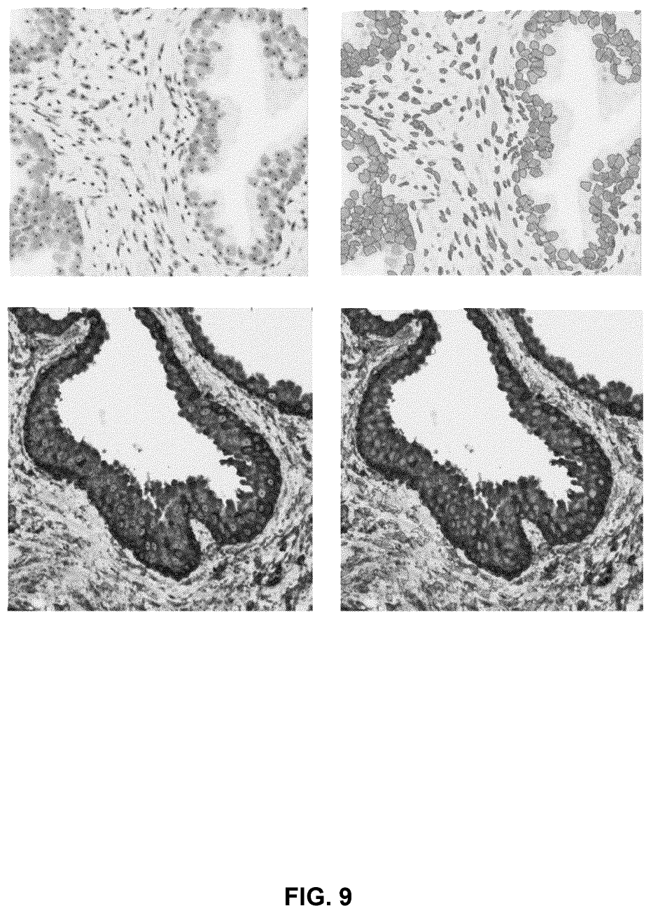

This Example relates to RNA dot counts in individual cells. The automatic nucleus detection was established to detect nuclei in the field-of-view images based on the Modified Radial Symmetry method. The two left images in FIG. 9 show the nucleus detection results of the Modified Radial Symmetry method overlaid on the original images of the no-probe control (top left) and strong staining images (bottom left. The two right images show the labels of the nucleus detection results overlaid on the original images of the no-probe-control (top right) and strong staining images (bottom right).

As shown in FIG. 9, the nuclei were detected and counted in the portion image. As a result, the average RNA dots can be reported within a single cell (RNA dots per cell). This statistic can be generated using RNA dots identified for kinds of cells (within a sample) or for only in tumor cells (within a sample).

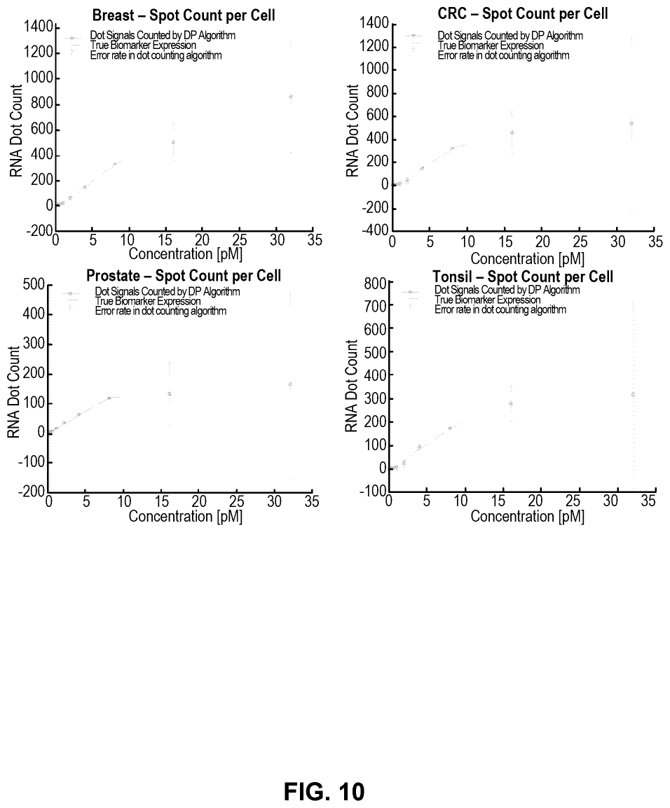

Using breast, prostate, CRC, and tonsil tissue, the spot signals per cell counted by DP algorithm with different concentrations were plotted together with the ideal biomarker expression lines and the error rate in dot counting algorithm, as shown in FIG. 10. Similar to the characteristics of the total spot counting, the true biomarker expressions are the linear fitting lines of the spot counts between 0 pM and 8 pM, which are the concentration range of the linear relationship, but with smaller error rates.

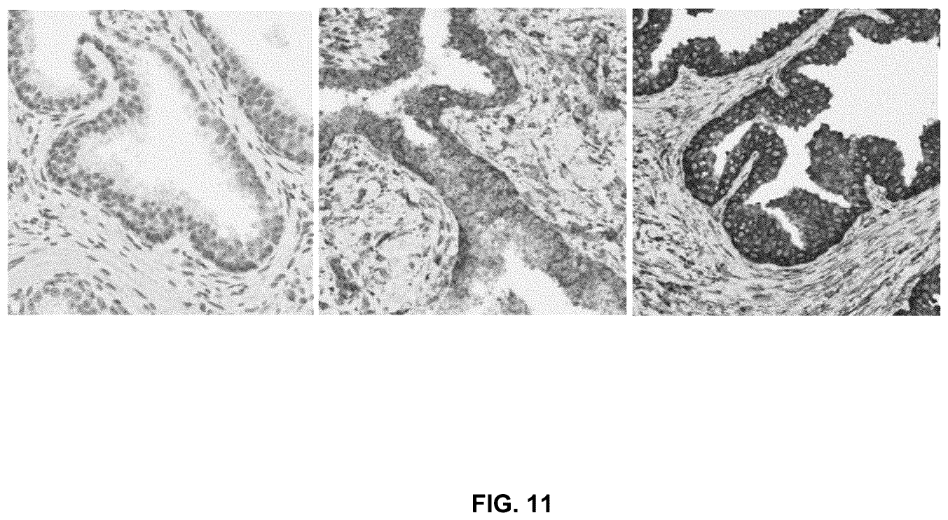

After investigating the characteristics of the RNA dot counting in different tissues, the RNA dot counting was investigated within only tumor regions. The automatic image-analysis was applied to classify tumor cells from stromal cells. FIG. 11 shows the examples of the tumor cells classification (red dots) from the non-tumor cells (green dots).

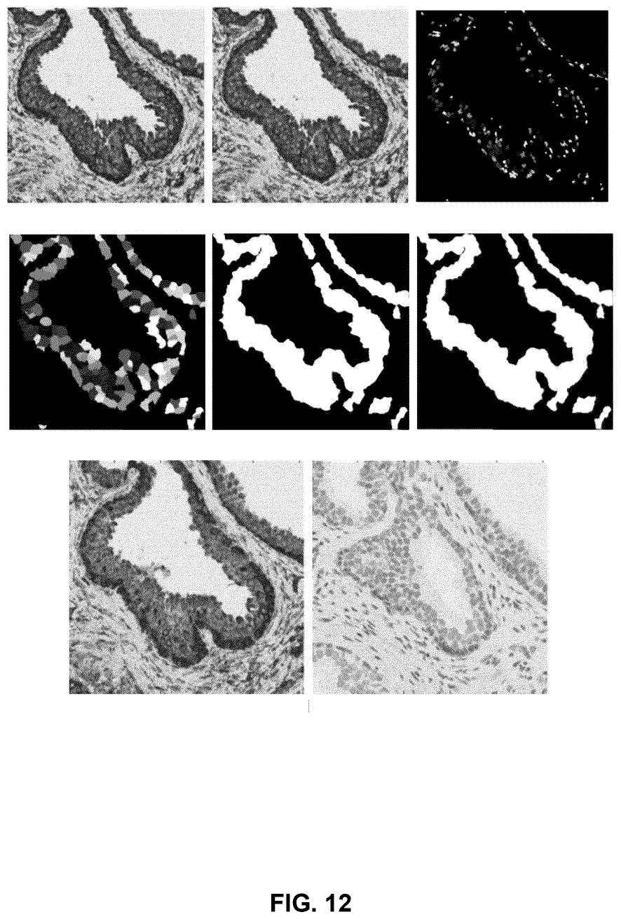

A framework was established to segment tumor regions out of non-target regions. Images in the top two rows of FIG. 12 illustrate the framework for generating a tumor mask starting from the cell-by-cell classification to group object of the tumor label images, the tumor mask, and the polygon generation. The bottom row shows the original images, which depict slides stained with the concentrations of 16 pM and 0 pM (NPC), overlaid with tumor polygons.

Notably, the experiment performed created artificial-truth data, given that it is known that the detected stain quantity should vary linearly with the different concentrations. However, it was unknown whether the detected signal would show this linearity, given that the stain may not be absorbed in a consistent manner and stain aggregates (e.g., blobs) may obscure what a true biomarker level is. Even though Example 1 demonstrated that the linearity exists when evaluating the stain levels expressed across groups of cells, this Experiment is considering how stain expression can be interpreted in an intra-cellular context.

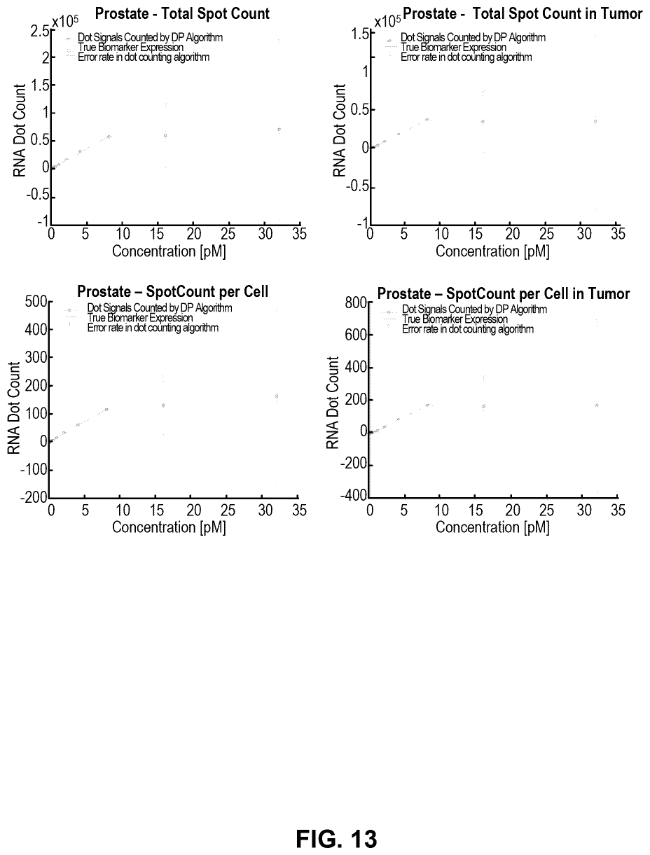

FIG. 13 shows four plots pertaining to prostate tissue, where the top two plots relate to total spot counts across all cells (left) or tumor cells (right). The bottom two plots relate spot counts per cell (left) or per tumor cell (right). The “true biomarker intensity” is the straight line that is defined as being linear fits corresponding to concentrations from 0-8 pM. FIG. 13 also shows the dot counts detected using standard digital-pathology techniques. The error bars in the figures show the error of the detected dot counts relative to the true biomarker levels. Across all four variables shown in FIG. 13, the error of the dot counts was very small until the cutoff point but then became very sizable at higher concentrations.

Thus, the data indicates that using a linear function (generated by fitting data that relates signal data to concentrations across pre-saturation concentration data) can be used to accurately relate signal intensities to predicted biomarkers up until a saturation point. Thereafter, the linear function can still be used to indicate a confidence or error of such biomarker predictions (where the error may become quite sizable).

### Example 3—Spot Characteristics With Different Concentrations

The above analysis concentrates on using intensity signals from digital pathology images to quantitatively predict biomarker presence. When investigating individual spots (or potentially even blobs), other characteristics of isolated spots may be informative about underlying biomarker levels. Therefore, for each isolated spot, metrics characterizing a size, blurriness and roundness of the signal of the spot were determined across stain concentrations (in addition to the spot's intensity). Notably, the intensity in the depicted boxplots illustrate that of isolated dots and not aggregate dots.

The metrics that characterized the blurriness and size of the spots did not vary with stain concentration. However, from the concentration of 0.0625 pM to 1 pM, the roundness features form close to the perfect round (=1). However, when reaching to the concentration of 2 pM, the roundness feature becomes distributing to close to imperfect round (=0) and becomes more uniform with greater standard deviations after the concentration of 8 pM. Therefore, techniques disclosed herein can be used to generate a linear function relating predicted roundness to concentration levels, to identify a saturation point as it applies to roundness predictions, and/or to generate error or confidence metrics for biomarker predictions based on roundness metrics of spots. Exemplary techniques for estimating characteristics of intensity, size, roundness and/or blurriness features are described in U.S. application Ser. No. 17/586,982, filed on Jan. 28, 2022, which is hereby incorporated by reference in its entirety for all purposes.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
accessing a digital pathology image that depicts a slide with a slice of a sample that was stained using a stain, wherein the digital pathology image was collected using bright-field imaging;
detecting a stain intensity that corresponds to at least part of the digital pathology image;
accessing a linear biomarker-intensity-prediction function that linearly relates predicted levels of biomarker intensities to detected intensities of the stain, wherein the biomarker-intensity prediction function was generated by assessing digital-pathology images of other slides, and wherein the other slides included samples stained with multiple other concentrations of the stain;
accessing a confidence function that relates confidences of a predicted biomarker intensity to the detected intensities of the stain, wherein the confidence function is non-linear;
generating a predicted biomarker intensity for the at least part of the slide based on the detected stain intensity that corresponds to the at least part of the slide and based on the linear biomarker-intensity-prediction function;
generating a confidence metric for the predicted biomarker intensity based on the detected stain intensity that corresponds to the at least part of the slide and based on the confidence function; and
outputting a result based on the predicted biomarker intensity and the confidence metric.

2. The computer-implemented method of claim 1, wherein the confidence function includes a first portion that linearly relates the confidences of the predicted biomarker intensity to the detected intensities of the stain, and wherein the confidence function includes a second portion that non-linearly relates the confidences of the predicted biomarker intensity to the detected intensities of the stain.

3. The computer-implemented method of claim 2, wherein the second portion of the confidence function corresponds to a saturation of the detected intensities of the stain.

4. The computer-implemented method of claim 1, wherein the at least part of the slide is a pixel, and wherein the method further comprises:
generating, for each of a set of other pixels in the digital pathology image, another predicted biomarker intensity for the other pixel based on the detected stain intensity that corresponds to the other pixel and based on the linear biomarker-intensity-prediction function;
generating, for each of a set of other pixels in the digital pathology image, another confidence metric for the other predicted biomarker intensity based on the detected stain intensity that corresponds to the other pixel and based on the confidence function; and
generating the result based on the predicted biomarker intensity, the other predicted biomarker intensities, the confidence metric and the other confidence metrics.

5. The computer-implemented method of claim 1, further comprising:
determining that a stored criterion is satisfied based on the confidence metric; and
based on the determination that the stored criterion is satisfied, generating the result in a manner that integrates the predicted biomarker intensity.

6. The computer-implemented method of claim 1, wherein the stain is an RNA stain.

7. The computer-implemented method of claim 1, wherein the stain is a stain for a nuclear protein.

8. The computer-implemented method of claim 1, wherein the stain is a stain for a cytoplasm protein.

9. A system comprising:
one or more data processors; and
a non-transitory computer readable storage medium containing instructions which, when executed on the one or more data processors, cause the one or more data processors to perform a set of operations including:
accessing a digital pathology image that depicts a slide with a slice of a sample that was stained using a stain, wherein the digital pathology image was collected using bright-field imaging;
detecting a stain intensity that corresponds to at least part of the digital pathology image;
accessing a linear biomarker-intensity-prediction function that linearly relates predicted levels of biomarker intensities to detected intensities of the stain, wherein the biomarker-intensity prediction function was generated by assessing digital-pathology images of other slides, and wherein the other slides included samples stained with multiple other concentrations of the stain;
accessing a confidence function that relates confidences of a predicted biomarker intensity to the detected intensities of the stain, wherein the confidence function is non-linear;
generating a predicted biomarker intensity for the at least part of the slide based on the detected stain intensity that corresponds to the at least part of the slide and based on the linear biomarker-intensity-prediction function;
generating a confidence metric for the predicted biomarker intensity based on the detected stain intensity that corresponds to the at least part of the slide and based on the confidence function; and
outputting a result based on the predicted biomarker intensity and the confidence metric.

10. The system of claim 9, wherein the confidence function includes a first portion that linearly relates the confidences of the predicted biomarker intensity to the detected intensities of the stain, and wherein the confidence function includes a second portion that non-linearly relates the confidences of the predicted biomarker intensity to the detected intensities of the stain.

11. The system of claim 10, wherein the second portion of the confidence function corresponds to a saturation of the detected intensities of the stain.

12. The system of claim 9, wherein the at least part of the slide is a pixel, and wherein the set of operations further comprises:
generating, for each of a set of other pixels in the digital pathology image, another predicted biomarker intensity for the other pixel based on the detected stain intensity that corresponds to the other pixel and based on the linear biomarker-intensity-prediction function;
generating, for each of a set of other pixels in the digital pathology image, another confidence metric for the other predicted biomarker intensity based on the detected stain intensity that corresponds to the other pixel and based on the confidence function; and
generating the result based on the predicted biomarker intensity, the other predicted biomarker intensities, the confidence metric and the other confidence metrics.

13. The system of claim 9, wherein the set of operations further comprises:
determining that a stored criterion is satisfied based on the confidence metric; and
based on the determination that the stored criterion is satisfied, generating the result in a manner that integrates the predicted biomarker intensity.

14. The system of claim 9, wherein the stain is an RNA stain.

15. The system of claim 9, wherein the stain is a stain for a nuclear protein.

16. The system of claim 9, wherein the stain is a stain for a cytoplasm protein.

17. A computer-program product tangibly embodied in a non-transitory machine-readable storage medium, including instructions configured to cause one or more data processors to perform a set of operations comprising:
accessing a digital pathology image that depicts a slide with a slice of a sample that was stained using a stain, wherein the digital pathology image was collected using bright-field imaging;
detecting a stain intensity that corresponds to at least part of the digital pathology image;
accessing a linear biomarker-intensity-prediction function that linearly relates predicted levels of biomarker intensities to detected intensities of the stain, wherein the biomarker-intensity prediction function was generated by assessing digital-pathology images of other slides, and wherein the other slides included samples stained with multiple other concentrations of the stain;
accessing a confidence function that relates confidences of a predicted biomarker intensity to the detected intensities of the stain, wherein the confidence function is non-linear;
generating a predicted biomarker intensity for the at least part of the slide based on the detected stain intensity that corresponds to the at least part of the slide and based on the linear biomarker-intensity-prediction function;
generating a confidence metric for the predicted biomarker intensity based on the detected stain intensity that corresponds to the at least part of the slide and based on the confidence function; and
outputting a result based on the predicted biomarker intensity and the confidence metric.

18. The computer-program product of claim 17, wherein the confidence function includes a first portion that linearly relates the confidences of the predicted biomarker intensity to the detected intensities of the stain, and wherein the confidence function includes a second portion that non-linearly relates the confidences of the predicted biomarker intensity to the detected intensities of the stain.

19. The computer-program product of claim 18, wherein the second portion of the confidence function corresponds to a saturation of the detected intensities of the stain.

20. The computer-program product of claim 17, wherein the at least part of the slide is a pixel, and wherein the set of operations further comprises:
generating, for each of a set of other pixels in the digital pathology image, another predicted biomarker intensity for the other pixel based on the detected stain intensity that corresponds to the other pixel and based on the linear biomarker-intensity-prediction function;
generating, for each of a set of other pixels in the digital pathology image, another confidence metric for the other predicted biomarker intensity based on the detected stain intensity that corresponds to the other pixel and based on the confidence function; and
generating the result based on the predicted biomarker intensity, the other predicted biomarker intensities, the confidence metric and the other confidence metrics.
